(19) United States
(12) Patent Application Publication
(10) Pub. No.: US 2004/0123513 A1
(43) Pub. Date: Jul. 1, 2004

(54) Emulsifier mixture for aqueous diesel emulsions

(76) Inventors: Frank Bongardt, Meersbusch (DE); Juergen Roeder, Duesselsdorf (DE)

Correspondence Address: COGNIS CORPORATION, PATENT DEPARTMENT, 300 BROOKSIDE AVENUE, AMBLER, PA, 19002, US

(21) Appl. No.: 10/473,117

(22) PCT Filed: Mar. 20, 2002
(86) PCT No.: PCT/EP02/03049

(30) Foreign Application Priority Data
Mar. 29, 2001 (DE) 101157053

(51) Int. Cl. C10L 1/32; B01F 17/00; B01F 3/08; C09K 3/00

(52) U.S. Cl. 44/301; 516/27; 44/302

(57) ABSTRACT

Aqueous diesel oils are disclosed which may be stored over several days without separating out as a result of the added emulsifier mixture.

This invention relates to an emulsifier mixture for aqueous diesel emulsions and to the use of certain emulsifier mixtures for the production of aqueous diesel emulsions.

In the combustion of hydrocarbons, nitrogen oxides and carbon monoxide are released in considerable quantities. Whereas, where gasoline is used; the corresponding reaction products can largely be bound by suitable catalysts, this is not readily possible in the case of diesel. However, it is known that the combination of diesel with water leads to fuels which have distinctly lower emission values than general diesel fuels.

Fuels in the context of the present invention are understood to be any energy-yielding working materials of which the free combustion energy is converted into mechanical work. Such materials include all types of motor and aircraft fuels which are liquid at room temperature and normal pressure. Motor fuels, for example for automobile and truck engines, generally contain hydrocarbons, for example gasoline or higher-boiling petroleum fractions.

Diesel fuels are low-inflammability mixtures of liquid hydrocarbons which are used as fuels for constant-pressure or compression-ignition engines (diesel engines) and which consist predominantly of paraffins with impurities in the form of olefins, naphthenes and aromatic hydrocarbons. Their composition is variable and depends in particular upon the production method. Typical products have densities of 0.83 to 0.88, boiling points in the range from 170 to 360° C. and solidus points at 70 to 100° C. Diesel oil is obtained in the distillation of petroleum from gas oil, during cracking, from the tars obtained in the low-temperature carbonization (or hydrogenation) of brown or hard coals and by hydrogenation of the coal extract.

Diesel oils for stationary plant and for marine engines are similar in composition to heavy fuel oil while those for automobiles, buses and trucks correspond to fuel oil. During combustion in a diesel engine, air is taken into the cylinder, heated to 550-900° C. by high compression (compression ratio 14:1 to 25:1), so that a jet of diesel injected in ignites spontaneously and reaches a combustion pressure of 50-80 bar at a combustion temperature of 1500-2200° C. so that the piston is moved and work is done. 13 m³ air are used in the combustion of 1 liter of diesel in the diesel engine. The combustion energy released amounts to ca. 42,000 kJ/kg. A key factor for the usability of diesel fuels is their ignition response which is quantitatively expressed by the cetane number. Ignition response is the capacity of a motor fuel to ignite relatively easily or with relative difficulty in an engine operating on the diesel principle. With every fuel, this requires not only atomization, pressure and temperature, but also a conditioning interval (ignition delay) before discernible combustion. Good ignition response of a fuel means favorable starting behavior and quiet running of the diesel engine by virtue of a short conditioning interval or small ignition delay. With a large ignition delay, the known phenomenon of “knocking” comes audibly into play. The requirements for diesel fuels are a cetane number of 20 to 40 for slow-running engines and a cetane number of >45 for small and fast-running engines. The quality features of diesel fuels also include low-temperature behavior which can be described by the cloud point or—nowadays preferably—by the cold filter plugging point (CFPP) which is the temperature at which diesel fuel “sucked” through blocks a filter. Other desirable properties include a low pour point, a low content of incombustible or soot-forming substances and a low sulfur content. For Europe, the standards and tests for diesel fuel are specified in DIN-EN 590 (May 1993). Cetane number improvers (saltpeter or nitrous ester), corrosion inhibitors, flow enhancers, surfactants (which keep the fuel injectors clean), defoamers and occasionally smoke reducers are introduced into the diesel as additives. Exhaust gases from diesel fuels contain more nitrogen oxides and 30 to 100 times more particles (“soot”) than those from spark ignition fuels after catalytic cleaning. The emissions from diesel engines are classified as carcinogenic according to the “MAK” List (Max. Workplace Concentration), Group III A2.

The problem of producing aqueous emulsions containing diesel oils as their oil phase is that the emulsions are extremely unstable, i.e. mixing or inversion of the emulsions can occur after only a few seconds. Stable diesel/water emulsions can be produced with the aid of suitable emulsifiers. Accordingly, the problem addressed by the present invention also was to produce diesel/water emulsions which would remain stable for much longer than the emulsions known from the prior art. It would be particularly advantageous if a diesel oil/water emulsion could be kept stable for several days. At the same time, however, it would be important to bear in mind that not all emulsifiers would be suitable for the production of such emulsions on account of their ecotoxicological properties. Accordingly, another problem addressed by the present invention was to provide emulsifiers which not only would enable diesel/water emulsions with long-term stability to be produced, the emulsions would also be ecologically satisfactory so that there would be no need, for example, for the nonylphenyl ethoxylate emulsifiers classified as hazardous or other toxic compounds.

It has been found that the problem stated above can be solved by combining various emulsifiers.

Accordingly, the present invention relates to an emulsifier mixture for aqueous diesel emulsions containing at least

a) fatty acid amides,

b) ethoxylated fatty acids,

c) alkoxylated fatty alcohols,

d) ethoxylated castor oil,

e) Guerbet alcohols and

f) solvents.

The individual substances present in the emulsifier mixture are well-known as such to the expert. It is crucial to the invention that, by specifically combining individual components a) to f) according to their chemical constitution, it is possible to produce stable aqueous diesel emulsions. The individual components are described in the following.

Component a)

The fatty acid amides are compounds corresponding to the general formula R—CO—NR². These compounds are obtained by known reactions between hydroxylalkylamines and carboxylic acid and are described, for example, in “Handbook of Surfactants”, M. R. Porter, Chapman and Hall, 1991, pages 135-139. The disclosure of the cited literature reference is also part of the present invention. Because of the method used to synthesize such compounds, secondary products, chiefly free hydroxylamine, are normally present in the components in addition to the actual amides. According to the invention, up to 5% by weight, as measured to DGFH/VI 4b, of free amines, based on the quantity of component a), may be present. Compounds of this type are also marketed by applicants under the name of Comperlan. Particularly preferred compounds are those in which the substituents R are symmetrical and stand for hydroxyalkyl groups, preferably ethyl groups.

It is particularly preferred to use tall oil derivatives and, more especially, tall oil fatty acid monoethanolamide. Tall oil itself is a mixture of fatty acids, resin acids, so-called oxyacids (inter alia oxidized resin and fatty acids) and other unsaponifiable components. Its composition varies greatly in dependence upon the nature of the wood being processed and its geographic origin: 15-55% fatty acids, ca. 20-65% resin acids, 1-8% oxyacids and 6-30% other unsaponifiable components for an acid value (AV) of ca. 90-160. Tall oil is fractionated by distillation into first runnings and tall oil pitch, which are mainly burnt, and into fatty acids and tall oil resin. At least 97% (top quality) of the tall oil fatty acids or 67% (with a resin acid content of 25-30%) consist of fatty acids (% by weight, based on the total quanity of fatty acids in brackets): lionoleic acid and conjugated C₁₈ fatty acids (45-65), oleic acid (25-45), 5,9,12-octadecatrienoic acid (5-12) and saturated fatty acids (1-3). Tall oil resin is made up of abietic acid (30-43%), dehydroabietic acid (21-35%), palustric acid (8-12%) and—in quantities of ca. 2-7% of each—dihydroabietic acid, neoabietic acid, pimaric and isopimaric acid besides 8-18% of other resin acids.

The compounds a) are preferably used as emulsifiers, but also for their foam-suppressing and corrosion-inhibiting properties. They are preferably present in the additives according to the invention in quantities of 15 to 25% by weight and more particularly in quantities of 18 to 23% by weight.

Component b)

Component b) also consists of known compounds which may be obtained in known manner by reaction of fatty acids, i.e. carboxylic acids containing 6 to 21 carbon atoms, and ethylene oxide in the presence of catalysts. Alkoxylated fatty acids have emulsifying properties and are also used accordingly in accordance with the present technical teaching. It is of particular advantage to use purely ethoxylated fatty acids. Ethoxylated fatty acids which contain 8 to 24 carbon atoms and, in particular, are unsaturated (16 to 18 carbon atoms should be present in the molecule) are particularly preferred for the purposes of the teaching according to the invention. They are reacted with 1 to 5 and preferably 1 to 3 parts of ethylene oxide per part of fatty acid. Component b) is preferably used in quantities of 12 to 18% by weight and more particularly in quantities of 13 to 16% by weight, based on the total quantity of the additive.

Component c)

The compounds c) are known substances which are obtained by reaction of fatty alcohols with alkoxides, preferably ethylene oxide and/or propylene oxide. Fatty alcohols are understood to be primary aliphatic alcohols corresponding to the formula R—OH where R is an aliphatic, linear or branched hydrocarbon radical containing 6 to 24 carbon atoms and 0 and/or 1, 2 or 3 double bonds. Typical examples are caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol and brassidyl alcohol and the technical mixtures thereof obtained, for example, in the high-pressure hydrogenation of technical methyl esters based on fats and oils or aldehydes from Roelen's oxo synthesis and as monomer fraction in the dimerization of unsaturated fatty alcohols. Preferred fatty alcohols are technical C₁₂₋₁₈ fatty alcohols such as, for example, coconut oil, palm oil, palm kernel oil or tallow fatty alcohol. The fatty alcohols are alkoxylated in known manner, compounds reacted with ethylene oxide and/or propylene oxide being preferred. In the case of mixed alkoxylates, the reaction may be carried out both blockwise and in randomized form. The fatty alcohols are preferably reacted with 1 to 15, preferably 1 to 10 and more particularly 1 to 5 parts ethylene oxide and/or propylene oxide. The alkoxylated compounds c) are used as emulsifiers. Component c) is preferably present in the additives according to the invention in quantities of 30 to 50% by weight and more particularly in quantities of 35 to 45% by weight.

Alkoxylated compounds which contain 6 to 24 carbon atoms and which have been reacted with ethylene oxide and/or propylene oxide are particularly preferred. Of these compounds, those in which 1 to 5 and preferably 1 to 3 parts of ethylene oxide and/or propylene oxide are present per part of fatty alcohol are preferred. It can also be of advantage to use mixtures of the compounds of component c) of which some parts are ethoxylated and the other parts are propoxylated.

Component d)

Ethoxylated castor oil is also a known compound. Castor oil is a pale yellow, viscous, inflammable, indigestible oil with a faint odor but an unpleasant taste which, by virtue of the double bond, thickens in air without solidifying as a thin film. 80 to 85% of castor oil itself consists of the glyceride of ricinoleic acid and additionally of the glycerides of acid (7%), acid (3%), palmitic acid (2%) and stearic acid (1%). Castor oil can be ethoxylated by any of the methods known to the expert. A preferred embodiment of the present invention is characterized by the use of ethoxylated castor oils in which there are 1 to 50 and preferably 5 to 25 parts ethylene oxide to one part castor oil. Castor oil derivatives containing 5 to 20 parts ethylene oxide per part castor oil are particularly preferred. The emulsifiers d) are present in the additives according to the invention in quantities of preferably 1 to 5% by weight and more particularly 1 to 2% by weight.

Component e)

Guerbet alcohols are known compounds which can be obtained by the so-called Guerbet reaction. The Guerbet reaction is a self-condensation of alcohols under the influence of sodium or copper at 200° C. and high pressure. It is assumed that, under the reaction conditions, the alcohol is first dehydrogenated to the aldehyde which then underdoes aldol addition on its own, after which the condensation product is hydrogenated to the alcohol, as illustrated in the following scheme:

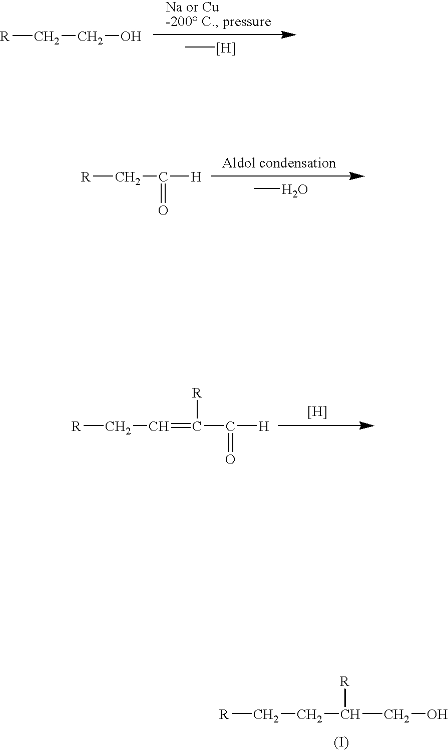

The alcohols obtained from the Guerbet reaction correspond to general structural formula (I), in which the R's may be hydrogen or, independently of one another, may represent C₁₋₁₈ alkyl groups. The Guerbet alcohols are generally 2-alkyl alkanols containing at least 6 and at most 36 carbon atoms. Besides the Guerbet reaction, there are other known methods for synthesizing alcohols corresponding to formula (I). For example, 2-ethyl-1-hexanol is industrially produced from butyraldehyde.

Alcohols suitable as component e) are, for example, 2-methyl-1-pentanol, 2-ethyl-1-hexanol, 2-propyl-1-heptanol, 2-butyl-1-octanol, 2-pentyl-1-nonanol, 2-hexyl-1-decanol, 2-heptyl-1-undecanol, 2-octyl-1-dodecanol, 2-nonyl-1-tridecanol, 2-undecyl-1-pentadecanol, 2-dodecyl-1-hexadecanol, 2-tridecyl-1-heptadecanol, 2-tetradecyl-1-octadecanol, 2-pentadecanol-1-nonadecanol, 2-hexadecyl-1-eicosanol, 2-heptadecyl-1-heneicosanol, 2-octadecyl-1-docosanol, 2-nonadecyl-1-tricosanol, 2-eicosyl-1-tetracosanol. Guerbet alcohols containing 14 to 18 carbon atoms are preferably used for the purposes of the present invention, 2-octyl-1-dodecanol being particularly preferred.

Component e) is preferably used as a solubilizer or viscosity adjuster in the mixtures according to the invention. Component e) is preferably present in the additives according to the invention in quantities of 2 to 5% by weight and more particularly in quantities of 3 to 5% by weight.

Component f)

The emulsifier mixtures according to the invention additionally contain solvents which may be selected from diesel and/or glycols and derivatives thereof. Mixtures of water, diesel oil and butyl glycol are particularly preferred. However, other solvents, more particularly propylene glycol and diethylene glycol, may also be used.

To produce the additives, components a) to f) are successively mixed and are then ready for use.

Particularly preferred emulsifier mixtures contain 18 to 22% by weight of fatty acid monoethanolamides, 14 to 18% by weight of ethoxylated C₁₄₋₁₈ fatty acids, 16 to 20% by weight of ethoxylated C₁₄₋₁₈ fatty alcohols, 10 to 14% by weight of propoxylated C₁₄₋₁₈ fatty alcohols, 2 to 5% by weight of Guerbet alcohols, 2 to 5% by weight of ethoxylated castor oil and, for the rest, solvents.

The emulsifier mixtures according to the invention are added to the aqueous diesel oils in quantities of 0.5% by weight to 4.0% by weight, preferably in quantities of 1.0% by weight to 2.5% by weight and more particularly in quantities of 1.0% by weight to 1.8% by weight. In this way, even diesel oils containing 20% by weight to 30% by weight of water can be stably emulsified. In addition, the emulsifier mixtures are free from toxicologically unsafe emulsifiers, for example nonyl phenol ethoxylates.

The present invention also relates to the production of aqueous diesel oils using the emulsifier mixtures described in the foregoing. The present invention also relates to a diesel oil containing at least 20% by weight of water and between 0.5 and 5% by weight and preferably between 1.0 and 2.5% by weight of an emulsifier mixture as described in the foregoing.

### EXAMPLES

An additive mixture according to the invention was prepared from the following components:

a) 21% by weight tall oil fatty acid monoethanolamide

b) 17% by weight tall oil fatty acid ethoxylated with 3 parts ethylene oxide

c) 19% by weight oleylcetyl alcohol ethoxylated with 3 parts ethylene oxide in admixture with a propoxylated oleylcetyl alcohol

d) 2% by weight castor oil ethoxylated with 3 parts ethylene oxide

e) 2% by weight C₁₆ Guerbet alcohol

f) rest water/diesel oil/butyl glycol

The above additive mixture was added in quantities of 1.5% by weight to a diesel oil emulsion containing 30% by weight water. A white emulsion still stable after 48 hours was spontaneously formed.

1. Emulsifier mixture for aqueous diesel emulsions containing at least
a) fatty acid amides,
b) ethoxylated fatty acids,
c) alkoxylated fatty alcohols,
d) ethoxylated castor oil,
e) Guerbet alcohols and
f) solvents.

2. Emulsifier mixture as claimed in claim 1, characterized in that component a) is present in quantities of 15 to 25% by weight and preferably in quantities of 18 to 23% by weight.

3. Emulsifier mixture as claimed in claims 1 and 2, characterized in that component b) is present in quantities of 12 to 18% by weight and preferably in quantities of 13 to 16% by weight.

4. Emulsifier mixture as claimed in claims 1 to 3, characterized in that component c) is present in quantities of 30 to 50% by weight and preferably in quantities of 35 to 45% by weight.

5. Emulsifier mixture as claimed in claims 1 to 4, characterized in that component d) is present in quantities of 1 to 5% by weight and preferably in quantities of 1 to 2% by weight.

6. Emulsifier mixture as claimed in claims 1 to 5, characterized in that component e) is present in quantities of 2 to 5% by weight and preferably in quantities of 3 to 5% by weight.

7. Emulsifier mixture as claimed in claims 1 to 6, characterized in that solvents f) are present in quantities of 5 to 50% by weight.

8. Emulsifier mixture as claimed in claims 1 to 7, characterized in that component a) is selected from monoethanolalkyl amides, preferably a tall oil fatty acid monoethanolamide.

9. Emulsifier mixture as claimed in claims 1 to 8, characterized in that component b) is selected from the group of ethoxylated C₈₋₂₄ monocarboxylic acids, preferably unsaturated C₁₆₋₁₈ fatty acids, the acids being reacted with 1 to 5 and preferably 1 to 3 parts ethylene oxide per part fatty acid.

10. Emulsifier mixture as claimed in claims 1 to 9, characterized in that component c) is selected from the group of ethoxylated and/or propoxylated fatty alcohols corresponding to the formula R—OH, in which R is a C₆₋₂₄ alkyl group.

11. Emulsifier mixture as claimed in claims 1 to 10, characterized in that component e) is selected from the group of C₁₄₋₁₈ Guerbet alcohols.

12. Emulsifier mixture as claimed in claims 1 to 11, characterized in that the solvents are selected from the group consisting of diesel oil, water, propylene glycol, butylene glycol and diethylene glycol.

13. Emulsifier mixture as claimed in claims 1 to 12, characterized in that it contains 18 to 22% by weight of fatty acid monoethanolamides, 14 to 18% by weight of ethoxylated C₁₄₋₁₈ fatty acids, 16 to 20% by weight of ethoxylated C₁₄₋₁₈ fatty alcohols, 10 to 14% by weight of propoxylated C₁₄₋₁₈ fatty alcohols, 2 to 5% by weight of Guerbet alcohol, 2 to 5% by weight of ethoxylated castor oil and, for the rest, solvents.

14. The use of the emulsifier mixtures claimed in claims 1 to 13 for the production of aqueous diesel oils.

15. Diesel oil containing at least 20% by weight of water, characterized in that it contains between 0.5 and 5% by weight and preferably between 1.0 and 2.5% by weight of the emulsifier mixture claimed in claims 1 to 14.
